(19) United States
(12) Patent Application Publication
(10) Pub. No.: US 2008/0120996 A1
(43) Pub. Date: May 29, 2008

(54) Method and Device for Tempering Glass Sheets

(75) Inventor: Herbert Radermacher, Raeren (BE)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 11/629,994

(22) PCT Filed: Jun. 14, 2005
(86) PCT No.: PCT/FR05/50442

§ 371 Date: Sep. 17, 2007

(30) Foreign Application Priority Data
Jun. 21, 2004 (DE) 10 2004 029 723.1

(51) Int. Cl. C03B 23/023; C03B 27/044; C03B 35/14

(52) U.S. Cl. 65/106; 65/104; 65/268; 65/244

(57) ABSTRACT

A method and a device for bending and cooling a glass pane or a bundle of glass panes, in which the glass panes heated to their bending temperature are bent in a horizontal position into a desired shape using a molding ring, and the bent glass panes placed on the molding ring are cooled in a cooling station by blowing cooling air using blowing plenums and then conveyed to a removal station. In the path between the bending station, the cooling station, the removal station, and its return to the bending station, the molding ring travels in an entirely closed path, particularly a circular path.

The invention relates to a method for bending and cooling or toughening glass panes which has the characteristics of the preamble of the independent method claim. The invention also relates to a device for bending and toughening glass panes which has the characteristics of the preamble of the independent device claim.

Car windows, building windows or window glass intended for other devices often has to be bent into a defined shape. For safety and/or mechanical strength reasons, it usually has to be toughened or partially toughened. The heat treatment in the manufacture of this window glass, which is known as simple safety glass, is carried out in bending and toughening furnaces. Laminated window glass is also known by way of safety glass able to react to high stresses and which meets defined requirements in terms of safety. This kind of glass is made up of two or more simple window glass panes joined together by an adhesive interlayer. The individual glass panes may then be just bent or in addition be completely or partially toughened. When the individual (or single) glass panes have to be partially or completely toughened, just like simple safety glass, they have to be transported individually through the device and then cooled quickly in order to create the desired stresses in the glass panes. When the glass panes have only to be bent and then cooled, they may also be processed in the device in the form of a bundle of superposed glass panes. In this case, they will usually be moved along through the device on transport molds of annular shape on which the bundle of glass panes is bent or prebent.

An individual glass pane is a single glass pane that does not form part of a bundle of glass panes.

A typical furnace for bending and toughening simple glass panes consists of a heating path, of a bending station, of at least one cooling station which cools the glass panes and, optionally, of a final cooling path situated downstream of each cooling station. In the heating path, the glass panes are transported in a horizontal position on a roller conveyor toward the bending station where they are heated to about 640° C. However, instead of resorting to a roller conveyor, it is also possible for the glass panes to be transported and heated in the heating path on the annular transport molds which are known in the devices for manufacturing laminated safety glass.

In the bending station, the softened glass pane is then lifted up off the bed of rollers by a pressure difference, bent using a curved bending mold, and set down on a transport ring which conveys the glass pane to the cooling station where it is prestressed. The bending mold may be a convex or concave mold and may have a solid surface or the form of a surround. Combinations of a convex bending mold and of a concave bending mold are also known, the convex bending mold often also being used to remove the glass panes from the roller conveyor and the annular concave bending mold to be used at the same time as a transport and/or toughening ring.

The shape of the glass pane may be created by the action of gravity, by kinetic energy as it is set down onto the transport and/or molding ring or by pressing the glass pane between the bending mold and the transport/molding ring.

Sudden cooling occurs in the cooling station by means of an airflow which acts on both sides of the glass pane in order to introduce the desired prestress into the glass.

The toughening operation requires more time than the operation of bending and preparing the heated glass pane. If a high pane output is desired, then two toughening stations may be provided, these then being arranged along the sides of the bending station. The direction of travel of the transport ring is then turned through 90° with respect to the direction in which the glass is transported on the roller conveyor. Beside the advantage of a higher production rate, this arrangement does, however, have several disadvantages. On the one hand, the softened glass panes are accelerated and transported in different directions which means that differences in shape may arise as a result of the various inertial and gravity forces to which they are exposed. Cooling also occurs under different conditions. Furthermore, the relatively expensive toughening stations, which have powerful fans and complicated blowing plenums, have to be produced in duplicate. When a final cooling path is provided for cooling the glass panes to a temperature close to ambient temperature, this cooling path has also to be provided in duplicate.

Application WO02/102728 discloses a bending and toughening device which does not entail laterally situated toughening stations, and a device the production rate of which is not tied to the time taken to toughen a glass pane. This device has a first toughening station and a second toughening station which are arranged one after the other in the direction of travel of the glass and is followed by a final cooling station. In the first toughening station, the glass pane is only partially toughened, the final desired values for the toughening being obtained in the second toughening station. A transport device provided with three rings for supporting and transporting the glass panes is operated there in such a way that, at the same time as a glass pane is then being transported out of the bending station, a second, partially toughened, glass pane is being transferred from the first to the second toughening station and a fully toughened third glass pane is being transferred from the second toughening station to the final cooling station. Furthermore, the airflows leaving the upper plenum and the lower blowing plenum are connected and disconnected in such a way that the glass panes are raised by means of a pressure difference across their ring until they come up against upper holding devices when the transport device enters the bending station. One disadvantage with this bending and toughening device is that it requires relatively complicated control systems; furthermore, an airflow is constantly leaving the blowing plenums, particularly even when the first transport panel enters the blowing station and an opening has therefore to be uncovered in the heating furnace; there is thus a risk of inadmissible cooling of the bending zone by the leakage flows.

The problem underlying the invention is that of proposing an improved bending and cooling method and a device suited to this purpose.

According to the invention, this problem is solved with the characteristics of the independent method claim and those of the independent device claim.

The characteristics of the dependent claims provide advantageous developments.

According to the invention, the usual back-and-forth movement of the molding ring between the bending station, the cooling station and the removal station is replaced by a movement in a completely closed path. The cooling station can then also be a toughening station, the toughening station being a special cooling station. The toughening of glass panes is, in fact, nothing more than a very rapid cooling of the glass panes. This technically very simple embodiment in the form of a completely closed path forms a circular path, but it is also possible to use closed paths of ellipsoidal shape or closed paths which exhibit straight sections.

The blowing plenums are provided with blowing jets as blowing nozzles.

The molding ring is moved in the completely closed path essentially always in the same direction, obviously except for any back-and-forth movement that may be necessary during the toughening operation. Unlike the methods of the prior art, the molding ring does not make a return movement.

The movement of the molding ring is generally not continuous, particularly in the bending station and in the cooling station (up to any back-and-forth movement there might be), it being possible for the movement in the closed path to be interrupted, and this then yields a “stop-and-go” operation characterized by startings and stoppings.

The invention is not restricted to the fact that the closed path is arranged in a single plane. If necessary, the molding ring can be moved to different heights as it travels along the closed path.

Although the invention speaks of a molding ring, the fact that the latter may also fulfill the toughening and/or bending functions in addition to its transport ring function must not, however, be excluded. The molding ring will be a transport ring in particular when the glass pane does not need to be toughening or when a bundle of glass panes placed on annular transport molds needs to be transported in the heating path in order there to be heated and bent or prebent.

The movement of the molding ring in the entirely closed path makes its return to the removal station and through the cooling station, superfluous. The molding ring thus enters the bending station via one side, and leaves via the opposite side and is then moved into the cooling station. The individual treatment stations, namely the bending station the cooling station and the removal station, have then obviously to be arranged in the closed path in which the molding ring moves.

When the molding ring moves in a closed path, another optional bending operation may also be performed with no problem in a second bending station situated between the actual bending station, situated at the end of the heating path, and the toughening station. Thus, for example in the bending station, the bending operation may be carried out by recourse to kinetic energy by allowing the softened glass pane to drop onto the molding ring, or by means of a thrusting operation, and during the second bending operation, it may be performed using the action of gravity on the softened glass pane.

The method according to the invention can be implemented in a particularly advantageous way if several molding rings are moving around the closed path. This is because a second molding ring is then always available in the bending station while the first molding ring is still in the cooling station, in one of the treatment stations situated downstream or is moving from the latter. If the molding rings are rigidly connected to one another, the distances between the molding rings may obviously correspond to the distances between the individual stations or may represent a multiple of the distances between the stations. That means that the individual molding rings connected fixedly to one another are always at the same angle to one another.

Particularly high rates can be achieved with the method according to the invention when the two molding rings at least provided are moved around the closed path independently of one another, in a non-uniform movement. In this case, the various durations of the individual stages of the method can be compensated for by accelerating the molding rings and/or giving them a speed as befits their position in the closed path. The method rate then depends only on the duration of the longest stage of the method because once this has been completed, a second molding ring is ready for this stage of the method, while the first molding ring is sent to the next stage of the method. Another advantage of the independent movement of the molding rings around the closed path lies in the fact that the individual treatment stations may be at any angle to one another. By virtue of that, the distance between the bending station and the cooling station may be particularly short so as to avoid undesirable thermal losses, while the distance between the cooling station and the removal station or between the removal station and the bending station may be tailored in any way to suit the features of the site.

The molding rings may be moved over the closed path in a particularly simple way by fixing each of them to an arm, the arms rotating about a common axis. The axis of rotation is generally situated at one of the ends of the arm (which are then said to be “cantilevered”). If necessary, the arms may be supported on a glideway, a roller line, or an air cushion. The invention obviously also encompasses other possibilities for the construction of the means of moving the molding rings in a closed path.

Other details and advantages of the subject of the invention will become apparent from the drawing of an exemplary embodiment and from the description which begins hereinabove, without in any way limiting the invention thereto.

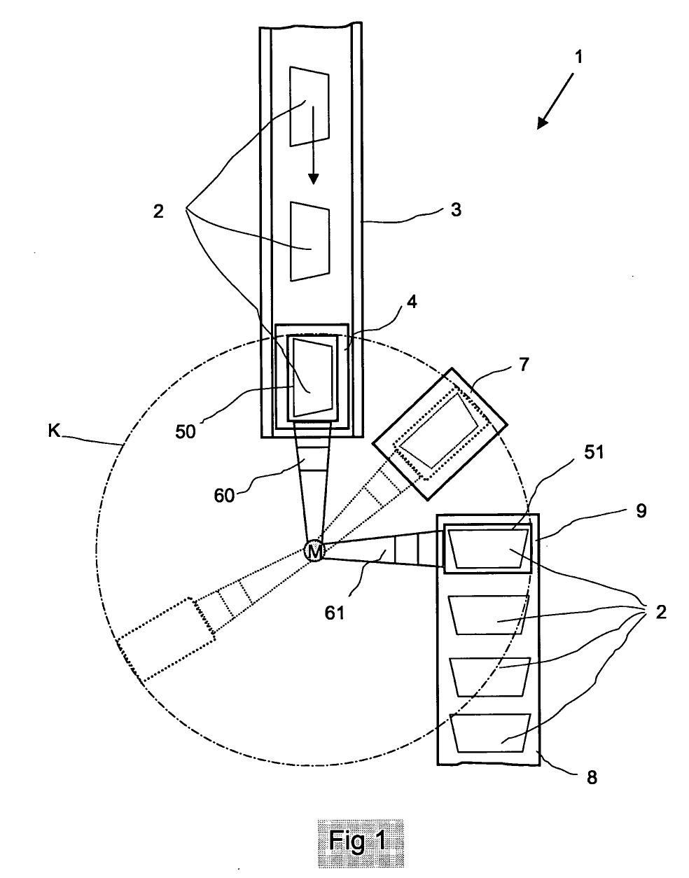

FIG. 1 depicts, in a very simplified way, a plan view of a rapid cooling device, that is to say of a device for toughening a glass pane according to the invention.

A device 1 is used to toughen glass panes 2 which have been heated in a furnace 3 while they are transported through the latter in the direction of the arrow on conveyor rollers, not depicted, until they reach their bending and toughening temperature. At the end of the furnace 3 there is a bending station 4 in which the glass panes 2 are raised above the conveyor rollers. The raising above the conveyor rollers may, for example, be performed by means of a suction plate which is brought from above close to the surface of the glass pane and then sucks the glass pane 2 via perforations made in the surface of the suction plate in order to lift it off the conveyor rollers. The suction plate may be flat or have a curvature that allows the glass panes 2 to be prebent. However, other methods of lifting up glass panes heated in a furnace are known. In most cases, the suction plate creates a pressure difference, for example lifting the glass pane above the transport plane by blowing from beneath. In another customary method, the pressure difference is brought about using an airflow at the periphery of the glass pane, after which a bell-shaped device is lowered over the glass pane.

Once the glass pane 2 has been lifted off the conveyor rollers, a molding ring 50 is moved into the bending station 4. The molding ring 50 is fixed to an arm 60 (cantilevering inasmuch as it rotates about an axis situated at one of its ends) and is moved in the clockwise direction in a closed path configured in the shape of a circular path K about the center M. When the molding ring 50 has been placed under the lifted-up pane of glass 2 in the bending station 4, the pane of glass is set down or dropped onto the molding ring which here is depicted only schematically. The glass pane 2 is then shaped by means of the action of gravity. The molding ring 50 carries the glass panes 2 at their periphery and has the outline of the desired curvature of the glass panes. If a suction plate with convex curvature is being used, a stage of bending by thrust against the molding ring is also possible.

After the bending operation, the glass pane 2 placed on the molding ring 50 situated in the circular path K is transported in the clockwise direction as far as a special cooling station, namely a toughening station 7 where it is thermally toughened by blowing cooling air. The parts of the device which contribute to this stage of the method are depicted in broken line because these steps are performed in succession. Next, the toughened glass pane is conveyed to a final cooling station 8 which contains a removal station 9 which removes the glass pane 2 from the molding ring 50 and cools it to the temperature required for the continuation of its treatment.

The device depicted contains a second molding ring 51 which is fixed to a second arm 61 (cantilever fashion) and also moves in the circular path K. The arms 60 and 61 have mutually independent drives and can move at different speeds and be accelerated independently of one another in the circular path K. During the toughening operation which, of the individual stages of the treatment, requires and ties up the molding ring for the longest length of time, the second molding ring can already enter the molding station and pick up the next pane of glass. In this way, the work rate can be considerably improved. Depending on the amount of space available, it is also possible to have a third and possibly further molding rings in the circular path in order to further improve the work rate.

1-15. (canceled)

16. A method for bending and cooling a glass pane comprising:
heating the glass pane to a bending temperature and bending the heated glass pane in a horizontal position into a desired shape using a molding ring;
cooling the bent glass pane placed on a molding ring in a cooling station by blowing cooling air using blowing plenums and then conveying the glass pane to a removal station;
wherein, in its path between the bending station, the cooling station, the removal station, and its return to the bending station, the molding ring travels along an entirely closed path, particularly a circular path, at least two molding rings being moved over the closed path and brought in succession to the bending stations, to the cooling station, and to the removal station, the molding rings being moved independently of one another over the closed path.

17. The method as claimed in claim 16, wherein each molding ring is fixed to an arm, the arms rotating about a common axis and having drives that are independent of one another and configured to move at different speeds and to be accelerated independently of one another along the circular path.

18. The method as claimed in claim 16, wherein the glass pane forms part of a pack of superposed glass panes.

19. The method as claimed in claim 16, wherein the glass pane is individual and the cooling is a toughening operation.

20. The method as claimed in claim 16, wherein, in its path between the bending station and the cooling station, the glass pane is conveyed to a second bending station that also lies in the closed path.

21. The method as claimed in claim 16, wherein the glass pane is removed from the removal station to be conveyed in a final cooling path.

22. A device for bending and cooling at least one glass pane, comprising:
a heating path for heating the glass pane up to the bending temperature;
at least one bending station, one cooling station, one removal station, and at least one molding ring;
wherein a guide device that guides the molding ring along an entirely closed path, particularly a guide path of circular shape, is provided between the bending station, the cooling station, the removal station, and back to the bending station, at least two molding rings being provided in the guide path, it being possible for the molding rings to be moved over the guide path independently of one another.

23. The device as claimed in claim 22, wherein each molding ring is fixed to an arm, the arms rotating about a common axis and having drives that are independent of one another and configured to move at different speeds and to be accelerated independently of one another along the circular path.

24. The device as claimed in claim 23, wherein between the bending station and the cooling station, there is a second bending station.

25. The device as claimed in claim 24, wherein the molding rings are connected to one another at least indirectly.

26. The device as claimed in claim 22, wherein a final cooling path is coupled to the removal station.
